(19) United States
(12) Patent Application Publication
(10) Pub. No.: US 2026/0095633 A1
(43) Pub. Date: Apr. 2, 2026

(54) ELECTRONIC DEVICE FOR GENERATING VIDEO CONTENT USING DIGITAL CONTENT BASED ON GENERATIVE ARTIFICIAL INTELLIGENCE MODEL AND METHOD THEREOF

(71) Applicant: Kakao Entertainment Corp., Seongnam-si (KR)

(72) Inventors: Sung A Jang, Seoul (KR); Gen Uk Song, Seongnam-si (KR); Mi Seon Kim, Seongnam-si (KR); Han Ju Park, Seongnam-si (KR); Myoung Ho Kim, Yongin-si (KR); Kwan Hee Han, Seoul (KR); Byung Hyun Ahn, Seoul (KR); Joo Won Choi, Seongnam-si (KR); Dae Hyun Baek, Seoul (KR); Su Kyeong Park, Seoul (KR)

(21) Appl. No.: 19/340,551

(22) Filed: Sep. 25, 2025

(30) Foreign Application Priority Data
Sep. 27, 2024 (KR) 10-2024-0131416

(51) Int. Cl. H04N 21/81

(52) U.S. Cl. CPC H04N 21/816; H04N 21/8113

(57) ABSTRACT

An electronic device for generating video content using digital content may include a processor configured to identify a plurality of cut images and text corresponding to the cut images by using digital content; input a first prompt including the cut images, the text, and analysis-based information into a generative artificial intelligence model to obtain analysis information on the digital content; input a second prompt including video asset information comprising the cut images, the text, and the analysis information, and narration generation-based information into the model to obtain narration information composed of a plurality of sentences; input a third prompt including the video asset information and matching-based information into the model to select at least one cut image among the cut images to be matched to each of the sentences; and generate video content by using the cut images and the narration information according to a selection result.

### CROSS-REFERENCE TO RELATED APPLICATION

The present application claims priority under 35 U.S.C. § 119 (a) to Korean patent application number 10-2024-0131416 filed on Sep. 27, 2024, in the Korean Intellectual Property Office, the entire disclosure of which is incorporated by reference herein.

### BACKGROUND

### 1. Technical Field

The present disclosure relates to an electronic device and a method for generating video content using digital content based on a generative artificial intelligence model.

### 2. Related Art

With the expansion of the digital content market, such as webtoons and web novels, and the inflow of new readers, marketing strategies have entered a new phase along with the explosive growth of online video-sharing platforms such as YouTube.

As one of the marketing strategies, the process of producing digital content into video content can generally be divided into four main stages: (1) creation of a synopsis and storyboard, (2) production of video image assets, (3) subtitle/narration work, and (4) video editing.

According to such a process, in order to produce a single video, a worker is required to read and understand the digital content, possess skills for handling editing programs, and so forth. Thus, the production hurdle is high, and it is difficult in that at least two to three weeks are required.

Meanwhile, generative artificial intelligence (GAI) is one of the artificial intelligence technologies that generates new content by using a deep learning model trained on a large-scale dataset.

With the advent of generative artificial intelligence models, new attempts have become possible to produce video content from digital content by utilizing such models.

The disclosure of this section is to provide background information relating to the present disclosure Applicant does not admit that any information contained in this section constitutes prior art.

### SUMMARY

The present disclosure is directed to providing an electronic device and a method for generating video content using digital content more quickly and easily.

An electronic device for generating video content using digital content based on a generative artificial intelligence model, according to an embodiment of the present disclosure, may include a processor configured to identify a plurality of cut images and text corresponding to the plurality of cut images by using digital content; input a first prompt including the plurality of cut images, the text, and analysis-based information into a generative artificial intelligence model to obtain analysis information on the digital content; input a second prompt including video asset information comprising the plurality of cut images, the text, and the analysis information, and narration generation-based information into the generative artificial intelligence model to obtain narration information composed of a plurality of sentences; input a third prompt including the video asset information and matching-based information into the generative artificial intelligence model to select at least one cut image among the plurality of cut images to be matched to each of the sentences; and generate video content by using the plurality of cut images and the narration information according to a selection result.

The analysis information may be analysis information on at least one of a character or a scene for each cut image of the digital content.

The processor may be configured to input a fourth prompt including the video asset information and synopsis generation-based information into the generative artificial intelligence model to obtain synopsis information on the digital content.

The processor may be configured to input a fifth prompt including the video asset information and character analysis-based information into the generative artificial intelligence model to obtain character information on the digital content.

The processor may be configured to convert the narration information into audio content.

The matching-based information may include at least one candidate cut image to be matched to each of the sentences and a score for the candidate cut image.

The processor may be configured to input a sixth prompt including the video asset information and use conditions for each image effect into the generative artificial intelligence model to select an image effect corresponding to each of the plurality of cut images.

The processor may be configured to identify at least one keyword for searching background music for the video content based on the video asset information, and select background music from a music database based on the at least one keyword.

A method performed by an electronic device for generating video content using digital content based on a generative artificial intelligence model, according to an embodiment of the present disclosure, may include identifying a plurality of cut images and text corresponding to the plurality of cut images by using digital content; inputting a first prompt including the plurality of cut images, the text, and analysis-based information into a generative artificial intelligence model to obtain analysis information on the digital content; inputting a second prompt including video asset information comprising the plurality of cut images, the text, and the analysis information, and narration generation-based information into the generative artificial intelligence model to obtain narration information composed of a plurality of sentences; inputting a third prompt including the video asset information and matching-based information into the generative artificial intelligence model to select at least one cut image among the plurality of cut images to be matched to each of the sentences; and generating video content by using the plurality of cut images and the narration information according to a selection result.

The method may further include inputting a fourth prompt including the video asset information and synopsis generation-based information into the generative artificial intelligence model to obtain synopsis information on the digital content.

The method may further include inputting a fifth prompt including the video asset information and character analysis-based information into the generative artificial intelligence model to obtain character information on the digital content.

The generating of the video content may include converting the narration information into audio content.

The generating of the video content may include inputting a sixth prompt including the video asset information and use conditions for each image effect into the generative artificial intelligence model to select an image effect corresponding to each of the plurality of cut images.

The generating of the video content may include identifying at least one keyword for searching background music for the video content based on the video asset information, and selecting background music from a music database based on the at least one keyword.

According to an embodiment of the present disclosure, the time required to convert the digital content into video content can be shortened, and even non-experts can easily and quickly create video content.

### BRIEF DESCRIPTION OF THE DRAWINGS

FIG. 1 is a schematic diagram illustrating an operation of an electronic device according to an embodiment of the present disclosure.

FIG. 2 is a block diagram illustrating a configuration of an electronic device according to an embodiment of the present disclosure.

FIG. 3 is a flowchart illustrating an operation of an electronic device according to an embodiment of the present disclosure.

FIG. 4 is a diagram illustrating video content being generated using digital content according to an embodiment of the present disclosure.

### DETAILED DESCRIPTION OF EMBODIMENTS

Hereinafter, embodiments according to the present disclosure will be described in detail with reference to the accompanying drawings. The detailed description to be disclosed hereinafter with the accompanying drawings is intended to describe embodiments of the present disclosure and is not intended to represent the only embodiments in which the present disclosure may be implemented. In the drawings, parts unrelated to the description may be omitted for clarity of description of the present disclosure, and throughout the specification, same or similar reference numerals denote same elements.

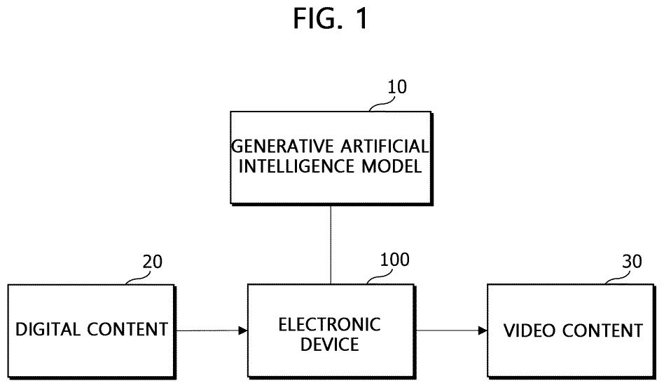

FIG. 1 is a schematic diagram illustrating an operation of an electronic device according to an embodiment of the present disclosure.

Referring to FIG. 1, an electronic device 100 according to an embodiment of the present disclosure is a device that generates video content 30 by using digital content 20 based on a generative artificial intelligence model 10 (hereinafter also referred to as model 10), and may be implemented as a computer, a server, a smartphone, a tablet PC, a smart pad, a notebook computer, and the like.

The generative artificial intelligence model 10 may be a language model trained to provide an answer corresponding to an input query, and may include, for example, a large language model (LLM) or a smaller large language model (sLLM).

In this case, the electronic device 100 may build and use the generative artificial intelligence model 10, or may receive and store a prebuilt generative artificial intelligence model 10 from the outside and use it. Alternatively, the electronic device 100 may use a prebuilt generative artificial intelligence model 10 that provides cloud-based services through a network. Hereinafter, the manner in which the electronic device 100 uses the generative artificial intelligence model 10 is not limited to any one of the above. In addition, the electronic device 100 may utilize two or more generative artificial intelligence models 10 in the process of generating the video content 30 by using the digital content 20.

The electronic device 100 may build one or more programs comprising one or more computer-executable instructions to generate the video content 30 from the digital content 20 by using the generative artificial intelligence model 10.

In the present disclosure, the digital content 20 may be story-based content including images, such as webtoons. In addition, the digital content 20 may include story-based content such as web novels and novels.

In the present disclosure, the video content 30 is a video generated by utilizing the digital content 20, and may be composed of a combination of images, subtitles, narration, image effects, background music, and the like. The video content 30 may be generated in various forms such as a short form or a long form. The video content 30 may be generated for various purposes such as promotion, preview, trailer, or summary of the digital content 20. In this case, the form or purpose of generating the video content 30 is not limited to any one.

In the present disclosure, a scheme is proposed for preparing basic materials for converting the digital content 20 into video content by utilizing the generative artificial intelligence model 10, and for automating the process to facilitate video generation.

Hereinafter, with reference to the drawings, the configuration and operation of the electronic device 100 according to an embodiment of the present disclosure will be described in detail.

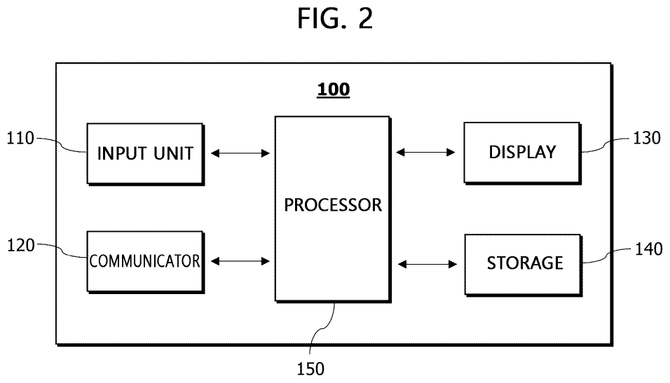

FIG. 2 is a block diagram illustrating a configuration of an electronic device according to an embodiment of the present disclosure.

The electronic device 100 according to an embodiment of the present disclosure may include an input unit 110, a communicator 120, a display 130, a storage 140, and a processor 150.

The input unit 110 generates input data in response to a user input of the electronic device 100. For example, the user input may be a user input for starting an operation of the electronic device 100, a user input for generating and tuning a prompt, or a user input for checking, modifying, and confirming a result obtained from the generative artificial intelligence model 10, or the like. In addition, any other user input necessary for generating the video content 30 by using the digital content 20 may also be applied without limitation.

The input unit 110 includes at least one input means. The input unit 110 may include a keyboard, a keypad, a dome switch, a touch panel, a touch key, a mouse, a menu button, or the like.

The communicator 120 may perform communication with an external device such as a server in order to transmit and receive the digital content 20, cut images, text, analysis-based information, analysis information, narration generation-based information, narration information, matching-based information, selection results, the generative artificial intelligence model 10, and the like.

To this end, the communicator 120 may perform wireless communication such as 5G (5th generation communication), LTE-A (Long Term Evolution-Advanced), LTE (Long Term Evolution), Wi-Fi (Wireless Fidelity), or Bluetooth, or wired communication such as LAN (Local Area Network), WAN (Wide Area Network), or power line communication.

The display 130 displays display data according to an operation of the electronic device 100. The display 130 may display a screen for separating cut images from the digital content 20 and extracting text, a screen for obtaining narration information and synopsis information by using video asset information such as a plurality of cut images, text, and analysis information, and a screen for selecting image effects, background music, and the like to be applied to the video content 30. Thus, the display 130 may display all or part of the process of generating the video content 30 by using the digital content 20.

The display 130 may include a liquid crystal display (LCD), a light emitting diode (LED) display, an organic LED (OLED) display, a micro electro mechanical systems (MEMS) display, or an electronic paper display. The display 130 may be combined with the input unit 110 to be implemented as a touch screen.

The storage 140 stores operation programs of the electronic device 100. The storage 140 includes a non-volatile storage capable of retaining data (information) regardless of power supply, and a volatile memory in which data to be processed by the processor 150 is loaded and which cannot retain the data without power supply. Examples of the storage include flash memory, a hard disc drive (HDD), a solid-state drive (SSD), and a read only memory (ROM), and examples of the memory include a buffer and a random access memory (RAM).

The storage 140 may store the digital content 20, cut images, text, analysis-based information, analysis information, narration generation-based information, narration information, matching-based information, selection results, the generative artificial intelligence model 10, and the like. The storage 140 may also store operation programs necessary for processes such as identifying the plurality of cut images and text, obtaining analysis information on the digital content 20, obtaining narration information, selecting cut images to be matched with the narration information, and generating the video content.

The processor 150 may execute software such as programs to control at least one other component (e.g., hardware or software component) of the electronic device 100, and may perform various data processing or computations.

The processor 150 according to an embodiment of the present disclosure may identify a plurality of cut images and text corresponding to the plurality of cut images by using the digital content 20, input a first prompt including the plurality of cut images, the text, and analysis-based information into the generative artificial intelligence model 10 to obtain analysis information on the digital content 20, input a second prompt including video asset information comprising the plurality of cut images, the text, and the analysis information, and narration generation-based information into the generative artificial intelligence model 10 to obtain narration information composed of a plurality of sentences, and input a third prompt including the video asset information and matching-based information into the generative artificial intelligence model 10 to select at least one cut image among the plurality of cut images to be matched to each sentence. The processor 150 may generate the video content 30 by using the plurality of cut images and the narration information according to the selection result.

In this case, the processor 150 may build and use the generative artificial intelligence model 10, or may receive and store a prebuilt generative artificial intelligence model 10 from the outside and use it. Alternatively, the processor 150 may use a prebuilt generative artificial intelligence model 10 that provides cloud-based services through a network. Hereinafter, the manner in which the processor 150 uses the generative artificial intelligence model 10 is not limited to any one of the above. In addition, the processor 150 may utilize two or more generative artificial intelligence models 10 in the process of generating the video content 30 by using the digital content 20.

Meanwhile, the processor 150 may perform at least some of the data analysis, processing, and result information generation for performing the above operations using at least one of machine learning, a neural network, and a deep learning algorithm as a rule-based or artificial intelligence algorithm. Examples of the neural network may include models such as a convolutional neural network (CNN), a deep neural network (DNN), a recurrent neural network (RNN), or a transformer.

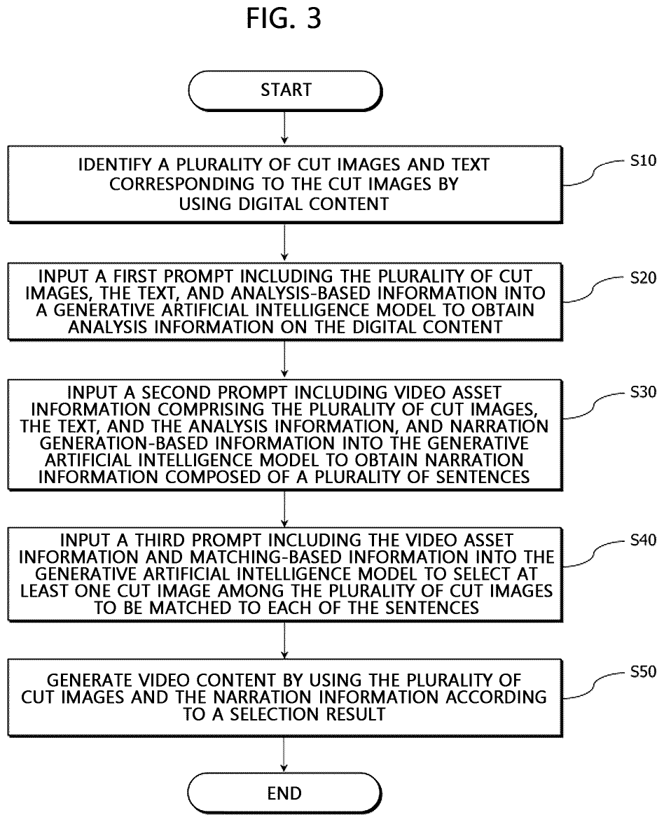

FIG. 3 is a flowchart illustrating an operation of an electronic device according to an embodiment of the present disclosure.

The processor 150 according to an embodiment of the present disclosure may identify a plurality of cut images and text corresponding to the plurality of cut images by using the digital content 20 (S10).

The digital content 20 may be story-based content including images, or story-based content not including images. The processor 150 may receive the required digital content 20 from a database storing the digital content 20 through the communicator 120, or may acquire the digital content 20 from the storage 140 implemented to include the database.

First, when the digital content 20 is story-based content including images, particularly digital content 20 such as a webtoon in which a long image is displayed by scrolling, it is necessary to separate the entire image into a plurality of cut images. A cut image is an image displayed in at least one frame of the video content 30. In this case, the size of the cut image may be variously set according to the video size, and after generating the cut image, the center or size of the cut image may be readjusted through object recognition or the like so that the cut image can be displayed in the video content 30.

The processor 150 may separate an image in the digital content 20 into a plurality of cut images. Various methods may be employed to generate the cut images. For example, the processor 150 may generate the cut images based on a heuristic algorithm that generates cut images using a background color as a reference, or based on an image processing model trained to separate images by performing object recognition in the entire image.

The processor 150 may identify text included in speech bubbles or written in the background of the plurality of cut images. Various methods may also be employed to identify the text. For example, the processor 150 may identify the text based on optical character recognition (OCR) technology.

Meanwhile, when the digital content 20 is story-based content not including images, cut images may be generated. For example, cut images may be generated by using the digital content 20 that is to be converted into video content, and portions corresponding to the cut images may be identified as text. Here, the portion corresponding to the cut image may refer to a text portion involved in generating the cut image among the story-based content not including images. Various methods may be employed to generate the cut images.

Hereinafter, the description will be given on the assumption that the cut images and the text corresponding thereto are obtained, regardless of the type of the digital content 20.

The processor 150 according to an embodiment of the present disclosure may input a prompt including a plurality of cut images, text, and analysis-based information (hereinafter referred to as a first prompt) into the generative artificial intelligence model 10 to obtain analysis information on the digital content 20 (S20).

A prompt is a query input into the generative artificial intelligence model 10, and may be prepared in advance so that the generative artificial intelligence model 10 can properly output results based on the given prompt. The prompt may generally include task information, background information, example information, persona information, and the like. The task information refers to information on a task that the model 10 is to perform, such as “please generate” or “please analyze.” The background information refers to information that serves as a background for the task so that the model 10 can perform the requested task more accurately. The example information refers to information describing examples of the results output by the model 10. The example information may include an output format of the results to be output. The persona information refers to information on a virtual person or role assigned to the model 10, for example, “you are a creative digital content creator” in the case of digital content generation. The prompt may be continuously tuned in the process of generating the video content 30 from the digital content 20 in order to obtain better results.

Meanwhile, this step is a step of training the generative artificial intelligence model 10 to understand the content of the digital content 20 and obtaining basic information (analysis information) for acquiring other information to be described later (also referred to as an image captioning step). The analysis information may include analysis information on at least one of a character or a scene for each cut image of the digital content 20.

The first prompt for obtaining analysis information on the digital content 20 may include analysis-based information. The analysis-based information may include task information requesting the model 10 to analyze the plurality of cut images and text. In addition, the analysis-based information may include the background information, example information, and persona information described above. In this case, the analysis-based information may include task information requesting not only an individual analysis of each cut image, but also an analysis of the story of the digital content 20 by understanding the context among the cut images.

Hereinafter, the plurality of cut images, text, and analysis information are basic information for generating the video content 30, and are collectively referred to as video asset information.

The processor 150 according to an embodiment of the present disclosure may input a prompt including the video asset information and narration generation-based information (hereinafter referred to as a second prompt) into the generative artificial intelligence model 10 to obtain narration information composed of a plurality of sentences (S30).

The second prompt for obtaining the narration information on the digital content 20 may include narration generation-based information. The narration generation-based information may include task information requesting the narration to be inserted into the video content 30 by using the video asset information. Similarly, in addition, the narration generation-based information may include the background information, example information, and persona information described above.

The processor 150 according to an embodiment of the present disclosure may input a prompt including the video asset information and matching-based information (hereinafter referred to as a third prompt) into the generative artificial intelligence model 10 to select at least one cut image among the plurality of cut images to be matched to each sentence (S40).

The third prompt for selecting at least one cut image among the plurality of cut images to be matched to each sentence may include matching-based information. The matching-based information may include task information requesting the selection of at least one cut image to be matched to each sentence of the narration information by using the video asset information. Similarly, in addition, the matching-based information may include the background information, example information, and persona information described above.

Meanwhile, the process of selecting cut images may be performed at once based on the matching-based information, but is not limited thereto and may be performed through a plurality of steps.

For example, the processor 150 may, through the model 10, select one or more candidate cut images among the plurality of cut images that are well-matched with each sentence of the narration information, and may assign a score to each candidate cut image. The score for each candidate cut image refers to a score assigned based on the relevance between each sentence and the corresponding candidate cut image. In this case, the matching-based information may include at least one candidate cut image to be matched to each sentence and a score for the candidate cut image. In this case, the processor 150 may input a third prompt including the video asset information and the matching-based information into the generative artificial intelligence model 10 to select at least one final cut image among the plurality of cut images to be matched to each sentence.

The processor 150 according to an embodiment of the present disclosure may generate the video content 30 by using the plurality of cut images and the narration information according to the selection result (S50).

The selection result is the result of selecting at least one cut image matched to each sentence of the narration information in step S40 described above.

The processor 150 may convert the narration information into audio content. The process of converting into audio content may be various. For example, the processor 150 may convert the narration information into audio content based on a text-to-speech (TTS) algorithm that converts text into speech. The TTS algorithm may be an artificial intelligence model trained to output speech corresponding to input text, and the artificial intelligence model may be trained based on the voice of a specific person. Alternatively, the processor 150 may use audio content in which the narration information is dubbed by an actual voice actor or the like.

The processor 150 may generate the video content 30 by combining the plurality of cut images and the audio content.

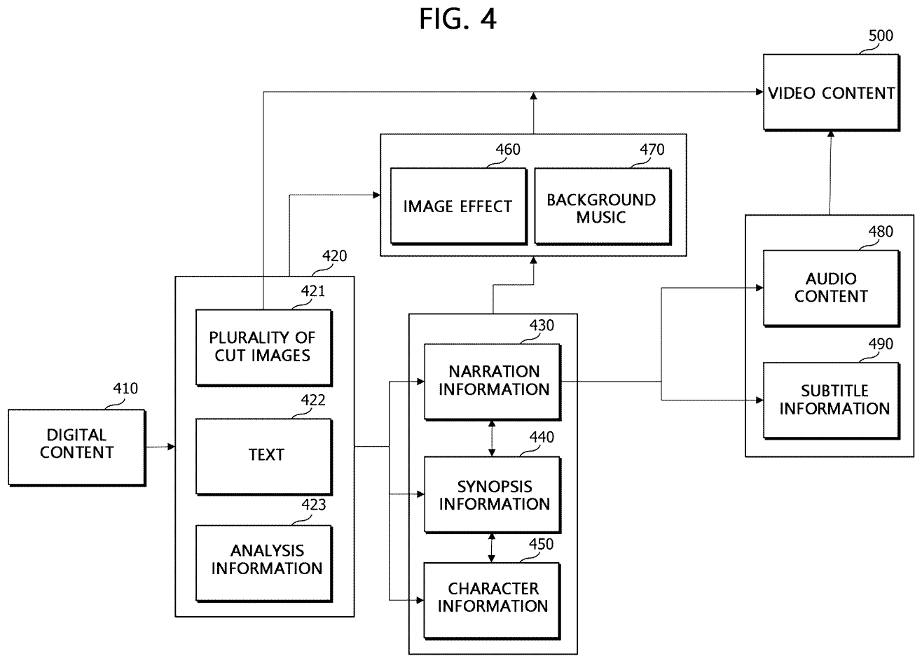

In this case, in addition to the plurality of cut images and the audio content, image effects or background music may also be inserted. This will be described with reference to FIG. 4.

According to an embodiment of the present disclosure, the entire process of generating the video content from the digital content may be performed automatically, or may include a step of verifying the result output from any one of the steps and regenerating it as needed.

According to an embodiment of the present disclosure, the time required to convert the digital content into video content can be shortened, and even non-experts can easily and quickly create video content.

FIG. 4 is a diagram illustrating video content being generated using digital content according to an embodiment of the present disclosure.

In the operation of generating the video content 500 from the digital content 410, the contents described above with reference to FIG. 3 are applied, and a description of overlapping contents will be omitted.

First, the electronic device 100 may obtain video asset information 420 from the digital content 410. The video asset information 420 may include a plurality of cut images 421, text 422, and analysis information 423.

The electronic device 100 may obtain narration information 430 by using the video asset information 420. In another embodiment, the electronic device 100 may obtain the narration information 430 by additionally considering synopsis information 440, which will be described later, in addition to the video asset information 420.

The synopsis information 440 may be used not only for the narration information 430 but also for image matching and background music extraction. The synopsis information 440 may be converted into TTS and updated as narration information, and each sentence may be segmented into an appropriate length to add subtitle information. The unit of segmentation may be determined by an artificial intelligence model.

The synopsis information 440 may also be used for image matching. The image matching may be performed by the artificial intelligence model identifying episodes of the synopsis, mentioned characters, related emotions, and the like. The electronic device 100 may obtain synopsis information 440 and character information 450 by using the video asset information 420.

Specifically, the electronic device 100 may input a prompt including the video asset information 420 and synopsis generation-based information (hereinafter referred to as a fourth prompt) into the generative artificial intelligence model 10 to obtain the synopsis information 440 on the digital content 410.

The fourth prompt for obtaining the synopsis information 440 on the digital content 410 may include synopsis generation-based information. The synopsis generation-based information may include task information requesting the model 10 to summarize the synopsis of the digital content 410 by using the video asset information 420. In addition, the synopsis generation-based information may include the background information, example information, and persona information described above. In this case, the synopsis generation-based information may include task information requesting not only an individual analysis of each cut image, but also an analysis of the synopsis of the digital content 410 by understanding the context among the cut images.

In another embodiment, the electronic device 100 may obtain the synopsis information 440 by additionally considering character information 450, which will be described later, in addition to the video asset information 420.

The character information 450 may identify who the main character is, what the name is, what the state is, and what the personality and appearance are, and may be used for generating the synopsis information 440 and for image matching.

The character information 450 may be extracted through the video asset information 420, and major events, scenes, and characters of the synopsis may be determined based on the character information 450. The synopsis information 440 may be extracted centering on the main character, and unnecessary mentions of other characters may be set to be excluded.

In addition, the character information 450 may also be used for the purpose of accurately matching images of characters mentioned in the synopsis information. In this case, state values of the characters that change according to the story development may be reflected. The state values of the characters may include external factors such as age, attire, hair length, and accessories.

The electronic device 100 may input a prompt including the video asset information 420 and character analysis-based information (hereinafter referred to as a fifth prompt) into the generative artificial intelligence model 10 to obtain the character information 450 on the digital content 410. The character information 450 may include information on the appearance and personality of characters appearing in the digital content 410.

The fifth prompt for obtaining the character information 450 on the digital content 410 may include character analysis-based information. The character analysis-based information may include task information requesting the model 10 to analyze characters appearing in the digital content 410 by using the video asset information 420. In addition, the character analysis-based information may include the background information, example information, and persona information described above. In this case, the character analysis-based information may include task information requesting not only an individual analysis of each cut image, but also an analysis of the characters of the digital content 410 by understanding the context among the cut images.

The electronic device 100 may input a prompt including the video asset information 420 and use conditions for each image effect 460 (hereinafter referred to as a sixth prompt) into the generative artificial intelligence model 10 to select the image effect 460 corresponding to each of the plurality of cut images.

The image effect 460 refers to an effect used to display the plurality of cut images 421 in the video content 500, and may include, for example, zoom in, zoom out, left in, right in, and the like.

The sixth prompt for selecting the image effects 460 on the digital content 410 may include use conditions for each image effect. The use conditions may include mandatory conditions and recommended conditions, where the mandatory conditions are conditions that must be satisfied in order to use the corresponding image effect. For example, the mandatory conditions may be the size or ratio of a cut image. The recommended conditions are conditions under which it is appropriate to use the corresponding image effect on the cut image. For example, zoom in is recommended when the corresponding cut image gives an impression of largely emphasizing or magnifying a single character (person) on the screen. In this case, the use conditions may include task information requesting not only an individual analysis of each cut image, but also an analysis of the image effects used before and after among the cut images, so as to select the image effect 460 for each cut image. In addition, the sixth prompt may include the background information, example information, and persona information described above.

In another embodiment, the electronic device 100 may select the image effect 460 for each cut image by additionally considering at least one of the narration information 430, the synopsis information 440, and the character information 450, in addition to the video asset information 420.

The electronic device 100 may identify at least one keyword for searching background music for the video content based on the video asset information 420.

The keyword may be identified from a predefined keyword list or may be identified from the video asset information 420. The predefined keyword list may be prepared, for example, by being divided into themes, genres, moods, and the like. Examples of themes may include adventure, fantasy, summer, thriller, and romantic. Examples of genres may include acoustic, blues, children's song, cinematic, classical, country, electronic, fantasy, folk, funk, hip-hop, holiday, indie, jazz, pop, and retro. Examples of moods may include epic, exciting, happy, and playful.

The electronic device 100 may select background music from a music database based on at least one keyword. The electronic device 100 may receive required background music from the music database through the communicator 120, or may acquire the background music from the storage 140 implemented to include the music database.

The electronic device 100 may obtain audio content 480 by using the narration information 430. In addition, the electronic device 100 may obtain subtitle information 490 by using the narration information 430.

The electronic device 100 may generate the video content 500 through a combination of the plurality of cut images 421, the image effects 460, the background music 470, the audio content 480, and the subtitle information 490 obtained through the processes described above.

The electronic device 100 may upload the generated video content 500 to a video providing service server such as YouTube, or may transmit the generated video content 500 to a user terminal so that the video content 500 can be utilized.

In addition, the electronic device 100 may directly play the video content 500 in a form viewable and audible by a user through the display 130 and a speaker.

What is claimed is:

1. An electronic device for generating video content using digital content based on a generative artificial intelligence model, the electronic device comprising:
a processor configured to:
identify a plurality of cut images and text corresponding to the plurality of cut images by using digital content;
input a first prompt including the plurality of cut images, the text, and analysis-based information into a generative artificial intelligence model to obtain analysis information on the digital content;
input a second prompt including video asset information comprising the plurality of cut images, the text, and the analysis information, and narration generation-based information into the generative artificial intelligence model to obtain narration information composed of a plurality of sentences;
input a third prompt including the video asset information and matching-based information into the generative artificial intelligence model to select at least one cut image among the plurality of cut images to be matched to each of the sentences; and
generate video content by using the plurality of cut images and the narration information according to a selection result.

2. The electronic device of claim 1, wherein the analysis information is analysis information on at least one of a character or a scene for each cut image of the digital content.

3. The electronic device of claim 1, wherein the processor is configured to input a fourth prompt including the video asset information and synopsis generation-based information into the generative artificial intelligence model to obtain synopsis information on the digital content.

4. The electronic device of claim 1, wherein the processor is configured to input a fifth prompt including the video asset information and character analysis-based information into the generative artificial intelligence model to obtain character information on the digital content.

5. The electronic device of claim 1, wherein the processor is configured to convert the narration information into audio content.

6. The electronic device of claim 1, wherein the matching-based information comprises at least one candidate cut image to be matched to each of the sentences and a score for the candidate cut image.

7. The electronic device of claim 1, wherein the processor is configured to input a sixth prompt including the video asset information and use conditions for each image effect into the generative artificial intelligence model to select an image effect corresponding to each of the plurality of cut images.

8. The electronic device of claim 7,
wherein the processor is configured to:
identify at least one keyword for searching background music for the video content based on the video asset information, and
select background music from a music database based on the at least one keyword.

9. A method performed by an electronic device for generating video content using digital content based on a generative artificial intelligence model, the method comprising:
identifying a plurality of cut images and text corresponding to the plurality of cut images by using digital content;
inputting a first prompt including the plurality of cut images, the text, and analysis-based information into a generative artificial intelligence model to obtain analysis information on the digital content;
inputting a second prompt including video asset information comprising the plurality of cut images, the text, and the analysis information, and narration generation-based information into the generative artificial intelligence model to obtain narration information composed of a plurality of sentences;
inputting a third prompt including the video asset information and matching-based information into the generative artificial intelligence model to select at least one cut image among the plurality of cut images to be matched to each of the sentences; and
generating video content by using the plurality of cut images and the narration information according to a selection result.

10. The method of claim 9, wherein the analysis information is analysis information on at least one of a character or a scene for each cut image of the digital content.

11. The method of claim 9, further comprising inputting a fourth prompt including the video asset information and synopsis generation-based information into the generative artificial intelligence model to obtain synopsis information on the digital content.

12. The method of claim 9, further comprising inputting a fifth prompt including the video asset information and character analysis-based information into the generative artificial intelligence model to obtain character information on the digital content.

13. The method of claim 9, wherein the generating of the video content comprises converting the narration information into audio content.

14. The method of claim 9, wherein the matching-based information comprises at least one candidate cut image to be matched to each of the sentences and a score for the candidate cut image.

15. The method of claim 9, wherein the generating of the video content comprises inputting a sixth prompt including the video asset information and use conditions for each image effect into the generative artificial intelligence model to select an image effect corresponding to each of the plurality of cut images.

16. The method of claim 15,
wherein the generating of the video content comprises:
identifying at least one keyword for searching background music for the video content based on the video asset information, and
selecting background music from a music database based on the at least one keyword.
